(19) United States
(12) Patent Application Publication
(10) Pub. No.: US 2009/0228359 A1
(43) Pub. Date: Sep. 10, 2009

(54) METHOD AND SYSTEM FOR ADVERTISING ON A SELF-SERVICE ORDER STATION

(75) Inventors: Brett Cameron, Buda, TX (US); John McDavitt, San Marcos, TX (US); Charles Marchant, Dale, TX (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: DNP PHOTO IMAGING AMERICA CORPORATION, San Marcos, TX (US)

(21) Appl. No.: 12/390,149

(22) Filed: Feb. 20, 2009

Related U.S. Application Data
(60) Provisional application No. 61/066,415, filed on Feb. 20, 2008.

(51) Int. Cl. G06Q 30/00; G06F 3/12; G06Q 50/00

(52) U.S. Cl. 705/14; 358/1.15

(57) ABSTRACT

The present invention provides a system and method for advertising on a self-service order station, such as a gift card kiosk or a photographic order fulfillment kiosk. The system comprises a self-service order station with a processing unit configured to execute a computer software program that enables the display of advertisements to a consumer who is utilizing the self-service order station. The self-service order station is capable of displaying advertisements on a user interface. The advertisements may be presented to the costumer in various locations within the user interface and in different formats. The method enables retailers to display exclusive advertisements on the self-service order station in some instances, while allowing for the display of multiple advertisements in other instances.

### CROSS-REFERENCE TO RELATED APPLICATIONS

This application claims the benefit under 35 U.S.C. § 119(e) of U.S. Provisional Application No. 61/066,415 entitled “GIFT CARD KIOSK,” filed on Feb. 20, 2008. U.S. patent application Ser. No. 12/077,431, entitled “GIFT CARD KIOSK,” filed Mar. 19, 2008, Patent Cooperation Treaty Application PCT/US08/03615, entitled “GIFT CARD KIOSK,” filed Mar. 19, 2008; U.S. Provisional Application 60/918,799, entitled “GIFT CARD KIOSK,” filed Mar. 19, 2007; and Provisional Application 61/066,415 are incorporated herein by reference in their entireties.

### BACKGROUND OF THE INVENTION

1. Field of the Invention

This invention relates to a method and system for advertising to consumers on a self-service order station, such as a gift card or photograph kiosk.

2. Description of the Background

Gift cards are generally displayed in racks at convenience stores and other retail stores. These display racks are bulky and require a substantial amount of space in the store. In some instances, gift cards may be distributed through card dispensers that allow a consumer to purchase a pre-valued and pre-printed card. At other times, the gift card value may be added to a magnetic stripe on the card at the time of purchase. Some other dispensers may allow a consumer to add certain content that is printed onto the card at the time of purchase. However, such card dispensers have traditionally offered the purchaser limited opportunity to exercise creativity in the creation of a customized gift card and, likewise, have offered little assistance to purchasers to help them select and customize a gift card so that it might be specifically tailored for the intended recipient of the card.

### SUMMARY OF THE INVENTION

The present invention provides a system and method for advertising on a self-service order station, such as a gift card kiosk or a photographic order fulfillment kiosk. With regard to a first aspect of a particularly preferred embodiment, the system comprises a self-service order station with a processing unit configured to execute a computer software program that enables the display of advertisements to a consumer who is utilizing the self-service order station. The self-service order station is capable of displaying advertisements on a user interface. The advertisements may be presented to the customer in various locations within the user interface and in different formats. In some instances, a single retailer may display one or more of its advertisements exclusively. In other instances, multiple advertisements from more than one retailer may be displayed simultaneously.

With regard to another aspect of a particularly preferred embodiment, a further embodiment of the present invention provides a self-service order station management system. The system enables control of one or more self-service order stations by a control center. The control center may provide advertisement information to each individual self-service order station it controls. The control center may also provide other information to be placed on the product being purchased. For example, the control center may provide stripe information to be encoded on a gift card being purchased at the self-service order station. A further embodiment provides a system of controlling multiple self-service order station networks by a central server. The central server may be in communication with the control centers of one or more self-service order station networks. The central server may provide further information to each control center for each self-service order station. Other and additional objects of this invention will become apparent from a consideration of this entire specification.

### BRIEF DESCRIPTION OF THE DRAWINGS

FIG. 1 is a graphical depiction of an exemplary self-service order station in accordance with a preferred embodiment of the present invention.

FIG. 2a is a graphical depiction of a first exemplary user interface suitable for use with the embodiment of FIG. 1.

FIG. 2b is a graphical depiction of a second exemplary user interface in accordance with the embodiment of FIG. 1.

FIG. 2c is a graphical depiction of a third exemplary user interface in accordance with the embodiment of FIG. 1.

FIG. 3 a diagram of a method of advertising in a self-service order station in accordance with another aspect of a preferred embodiment of the present invention.

FIG. 4 is a graphical depiction of a self-service order station network in accordance with another aspect of a preferred embodiment of the present invention.

FIG. 5 is a graphical depiction of two self-service order station networks connected to a central server in accordance with yet another aspect of a preferred embodiment of the present invention.

### DETAILED DESCRIPTION

The invention summarized above and defined by the enumerated claims may be better understood by referring to the following description, which should be read in conjunction with the claims and accompanying drawings in which like reference numbers are used for like parts. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

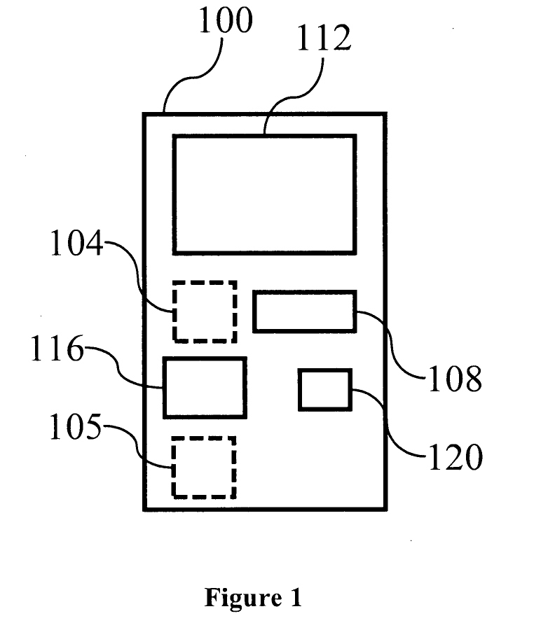

In one preferred embodiment of the present invention, as shown in FIG. 1, a self-service order station 100 is provided. The self-service order station may be a gift card kiosk, a photographic kiosk, and other devices that allow a consumer to place and retrieve orders for specific products. The self-service order station 100 comprises a user interface 112; a product delivery apparatus 108; and a processing unit 104. The product delivery apparatus may be a device such as a photographic printer, a gift card printer, and a card printer; a magnetic stripe encoding apparatus, and other such devices, which allow the self-service order station 100 to deliver a product to the consumer using the self-service order station. The processing unit 104 is communicatively connected with the user interface 112 and the product delivery apparatus 108. The self-service order station 100 may also include a payment processing mechanism 120, a media reader 116, and a media storage device 105, which are also communicatively connected to the processing unit 104. The processing unit 104 may be configured to execute a computer software program, which enables a method for the presentation of advertisements to a consumer on the user interface 112. The computer software program may be located directly on the processing unit 104, a media storage device 105, or any other location accessible to the processing unit 104 that allows the execution of the method set forth herein for advertising on the self-service order station 100.

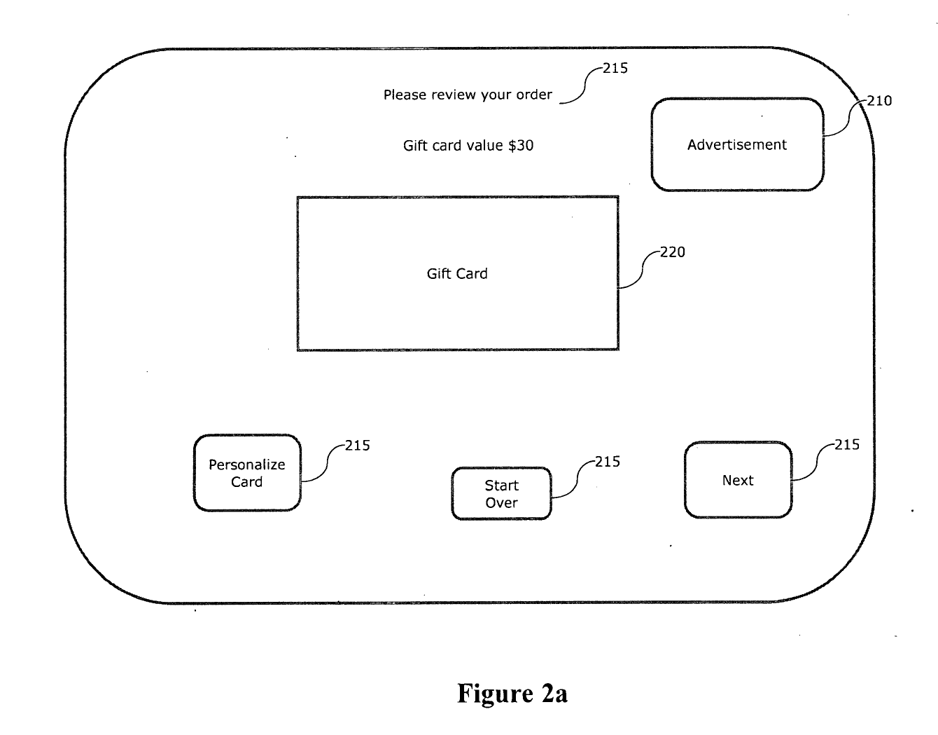

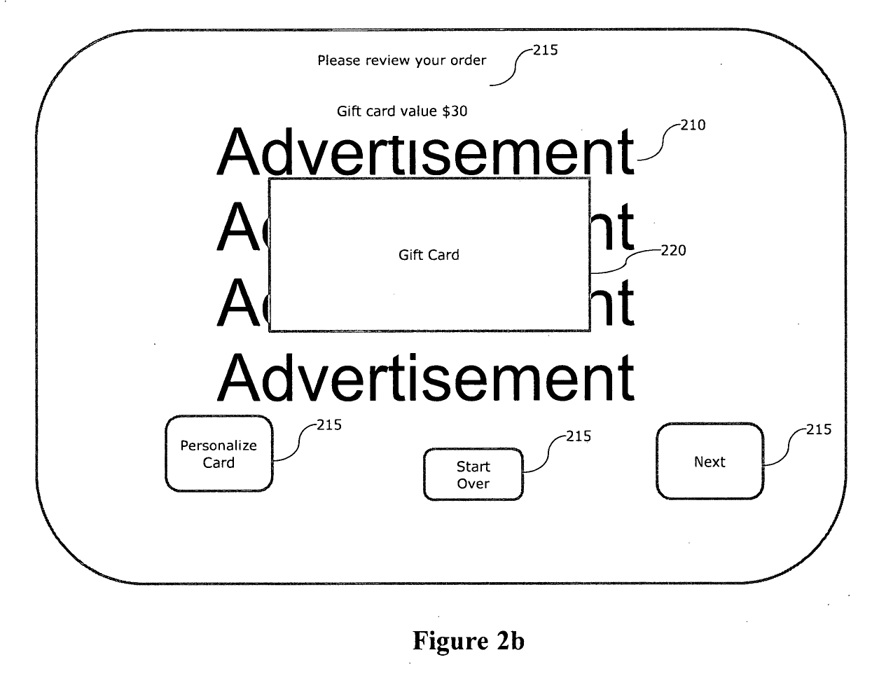

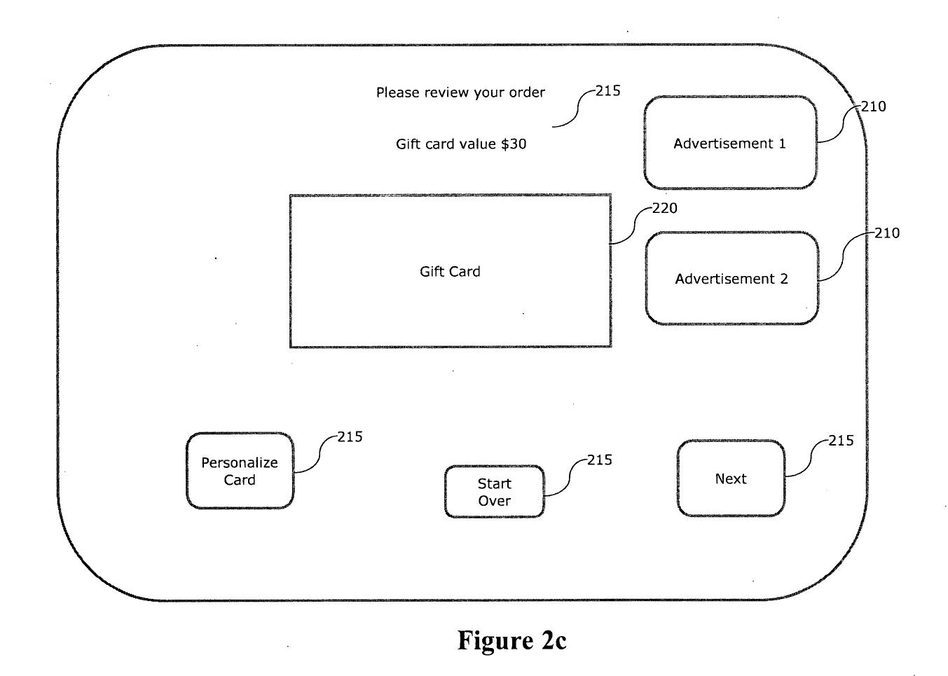

As shown on FIGS. 2a through 2c, the method executed by the processing unit 104 places advertisements 210 from various retailers at various locations on the user interface 112 that do not interfere with the messages 215 and sample product (e.g., sample gift card or photograph) 220 being displayed to the consumer for the purchase of a particular product. In FIG. 2a, for example, an advertisement 210 may be presented to the consumer on the right hand side of the user interface 112. An advertisement 210 may also be displayed across the top or bottom of the user interface 112. In some instances, the advertisement 210 may be utilized as the background of the user interface 112, as shown on FIG. 2b. When an advertisement 210 is displayed as the background to the user interface 112, the sample product 220 is displayed in the foreground. The user interface 112 may display more than one advertisement 210, as shown on FIG. 2c. The location of the advertisement 210 may be determined from attributes assigned to the advertisement 210. The attributes may be selected by the retailer or individual who purchased the advertisement space.

Advertisements may be presented to the customers in a variety of forms. The advertisement may consist of a traditional fixed presentation, a banner, a logo, or other non-animated media. The advertisements may also consist of animated media such as traditional television commercials, short videos, viral videos, animated cartoons, or other animated media the retailer may choose for display to the consumer. It is contemplated that some of these advertisements may be silent in nature and others may include sound. Silent animated advertisements may include closed captions and/or subtitles in different languages.

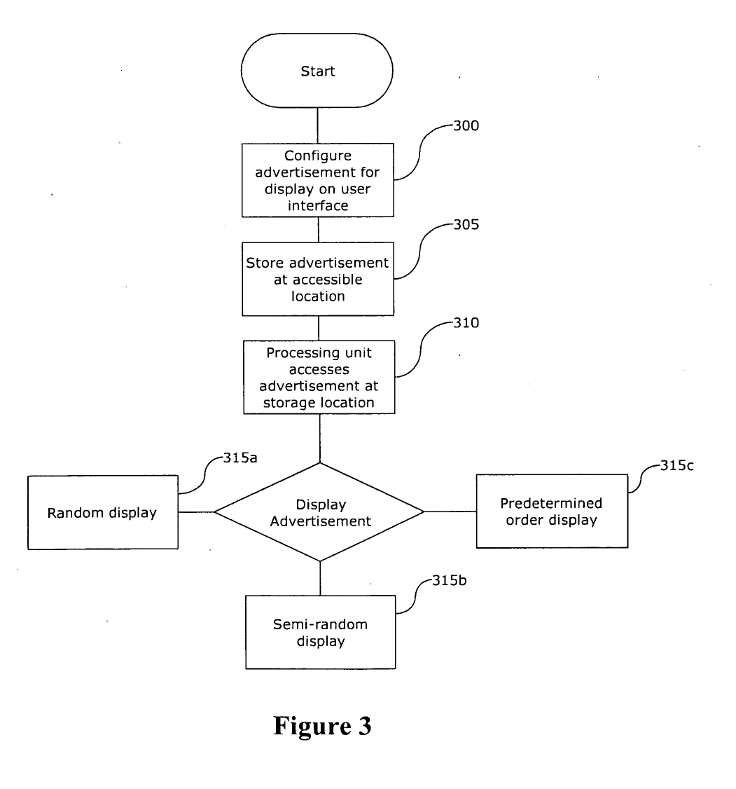

The method executed by the processing unit 104 is provided in FIG. 3. At a first step 300, an advertisement is configured for display on the user interface 112. The configuration of the advertisement consists of assigning specific attributes to the file that contains the particular advertisement 210 to be displayed. The attributes assigned to the advertisement may include, for example, the retailer, the type of advertisement (animated or fixed), preferred location, mode of display (exclusive or non-exclusive), frequency in which the advertisement may be displayed to customers, and other attributes that allow the processing unit 104 determine when, where, what, and how often a particular advertisement may be displayed.

At a second step 305, the advertisement file is stored at a location that is accessible to the processing unit 104. For example, the advertisements may be included on a database that is loaded onto a media storage device 105 within the self-service order station 100. The advertisement 210 may also be placed at a remote storage location accessible to the processing unit 104 through a network, such as a local area network or a global network, such as the Internet. At another step 310, the processing unit 104 accesses the storage location where the advertisement 210 is stored and retrieves the advertisement 210. The processing unit 104 may then display the advertisement 210 on the user interface 112 in accordance with the previously assigned attributes as shown at steps 315a, 315b, or 315c.

The processing unit 100 may be configured to present advertisements 210 in a random 315a, semi-random 315b, or predetermined order 315c. In a random 315a selection pattern, the processing unit 104 selects an advertisement to be presented to the consumer through a randomization algorithm where the advertisement 210 is selected from the list of advertisements by chance. In the semi-random 315b step, the processing unit 104 may initially select one of the advertisements randomly and then select the remaining advertisements in the order they appear on the list of advertisements. Alternatively, the attributes assigned to each advertisement may be weighed to cause the processing unit 104 to select a particular advertisement 210 more or less frequently than other advertisements 210. In a predetermined order 315c step of the present invention, the processing unit 104 is directed to select and display advertisements in the particular order that the advertisements have been placed on the advertisement database, or in such other pre-defined order as may be desired.

With regard to another aspect of a preferred embodiment of the invention, the processing unit 104 may display only one advertisement 104 to a particular customer during the customer's interaction with the self-service order station 100. Alternatively, the processing unit 104 may present a new advertisement or a set of advertisements after a pre-determined time period or when the user interface 112 provides additional viewing screens to the customer. For example, one advertisement 210 may be presented upon selection of the type of a product/gift card, and a second advertisement may be presented with the preview of the product/gift card that a particular customer is purchasing.

In another aspect of a preferred embodiment of the present invention, the processing unit 104 may execute instructions that allow a particular advertisement 210 to be presented to the customer multiple times, either consecutively or randomly and for pre-determined lengths of time. The advertisement may have an attribute that is recognized by the processing unit 104 and allows for the selection of advertisements to be shown exclusively for a specified number of consecutive displays. For example, a retailer may purchase the number of times their advertisement will be displayed to consumers in a consecutive basis and such attribute may be assigned to the particular advertisement for display. Alternatively, the attribute may determine the length of time an advertisement may remain on the user interface as the costumer is placing his or her order.

In one additional aspect of a preferred embodiment of the present invention, multiple advertisements 210 from more than one retailer may be displayed on the user interface 112 at the same time. Alternatively, the advertisement 210 may contain an exclusive attribute and may not be displayed with any other advertisements 210. If there are one or more exclusive advertisements 210, the advertisements 210 may be displayed at the user interface 112 on an alternative basis. For example, one exclusive advertisement 210 from a retailer may be presented to a consumer when the consumer begins to utilize the self-service order station 100. A second exclusive advertisement 210 from the same or a different retailer may be presented when the user interface 112 display changes.

The retailer may have the ability to select the section of the user interface 112 where the retailer prefers to display the advertisement 210 and such selection may be included as an attribute of the file recognized by the processing unit 104. Multiple advertisements 210 may be located on a similar location on the user interface. Advertisements may be displayed on the right side of the screen arranged in a column with a first advertisement being displayed at the top of the screen and a second advertisement below the first, as shown on FIG. 2c. This pattern may continue for more than two advertisements. Multiple advertisements may also have different sizes or be of uniform size. In some cases, the advertiser may have the opportunity to purchase an advertisement that is larger than the others presented on the user interface 112 or present the advertisement 210 in a more prominent position. The advertisement 210 may be given a specific attribute that directs the processing unit 104 to display the advertisement 210 in the specific manner assigned to that particular attribute.

With regard to another aspect of a preferred embodiment of the invention, advertisements 210 may be displayed according to categories available to the product/gift card purchaser. When selecting a product/gift card for purchase, customers may be presented with a number of categories from which to choose the type of product/gift card the customer would like to purchase. For example, the customer may be presented with a selection from boys, girls, women, or men. When the customer selects one of those options, further options are provided such as a number of retailers available at the self-service order station 100 for purchasing a product/creating a gift card. Each advertisement 210 may be assigned attributes in order to allow grouping of the advertisements 210 by the categories available to customers through the self-service order station 100. The advertisement's 210 attributes allow delivery of advertisements 210 that may be of particular interest to the consumer utilizing the self-service order station 100. As the consumer makes selections from the user interface 112 for specific categories, advertisements 210 related to those categories may be presented to the consumer as described previously. This function allows retailers to target their advertisements 210 to specific types of consumers, who are likely to be reached by the advertisement 210, and maximizes the retailer's benefit for placing an advertisement 210 on the self-service order station 100. The categories may include product characteristics, demographic characteristics, and any other characteristic a person of ordinary skill in the art would recognize as beneficial for delivering appropriate advertisements to potential consumers.

The self-service order station 100 may be enabled to allow a consumer to select an advertisement 210 that has been presented to the consumer. When a consumer selects an advertisement 210, a product/gift card 220 associated with that advertisement 210 is presented on the user interface 112. For example, if a consumer selects an advertisement 210 from Retailer A, a gift card for that retailer may be displayed to the consumer for customization.

In a further aspect of a preferred embodiment of the invention, the self-service order station 100 may be assigned a discrete identifier. The discrete identifier may, for example, allow the processing unit 104 to identify where the self-service order station is located. In addition, a database of advertisements may be created. Each advertisement on the database may be assigned a second discrete identifier. It is contemplated that some advertisements may have the same identifier. For example, sports advertisements for a specific team may be assigned a specific second discrete identifier and advertisements for retailers in a specific locality may share the same second discrete identifier. When selecting an advertisement to be presented to the consumer, the processing unit may select advertisements whose second discrete identifiers are similar to the discrete identifier of the self-service order station 100.

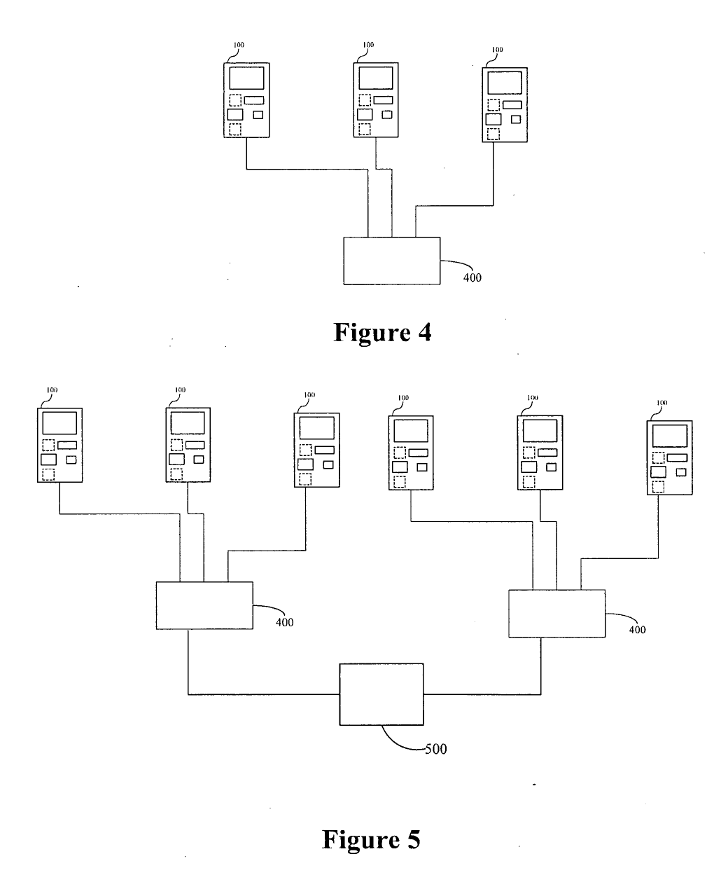

The self-service order station 100 may be connected to a network, as shown in FIG. 4. The network may include one or more self-service order stations 100 communicatively connected to a control center 400. It is contemplated that a self-service order station 100 provider may link all of its self-service order stations 100 to its own network. For example, one Retailer A may connect some or all of its self-service order stations 100 to that retailer's control center 400. The self-service order stations 100 connected to the control center 400 may be located at the same physical location (e.g., store) or at different physical locations (e.g., different stores in different cities). Alternatively, it is contemplated that multiple self-service order station providers/retailers may connect their self-service order station 100 networks to a larger network controlled by a central server 500, as shown in FIG. 5. For example, multiple retailers may allow a third party to manage the retailers' self-service order stations 100. The third party may allow a number of retailers to connect their self-service order station 100 networks to the third party's central server 500. The control center 400 of the different networks may be connected to the central server 500. The network preferably allows the self-service order stations to be remotely updated. For example, the network may allow self-service order stations 100 for gift cards to be connected with one or more payment processors for obtaining the required information to be placed on a gift card's magnetic stripe. The network also allows the self-service order stations 100 to maintain up to date information from the retailers. For example, the network may be utilized to update the advertisement database for each self-service order station 100.

Each self-service order station on a network may be given a discrete and specific identification. The discrete identification may be an identification number, an alphanumeric identification, an alphabetic identification, or any other type of identification understood by those skilled in the art to provide a discrete identifier for each self-service order station 100. Each self-service order station 100 may also be identified by an Internet Protocol (IP) Address or other identification methods that provide reliability and security. Similarly, the control center 400 and the central server 500 may also be assigned specific identification characteristics that may be recognized by each self-service order station 100, control center 400, or central server 500, for enhanced security and communication.

The independent network control centers 400 and/or the central server 500 may utilize a consumer card content management software that allows retailers to control what is provided on each individual self-service order station 100. The consumer card content management software allows the retailer to determine what advertisements may be presented to the consumers purchasing cards, the content of the cards, and the available fonts, pictures, symbols and media that may be included on the cards.

The consumer card content management software may also allow the retailers to isolate individual self-service order stations 100 for specific purposes. For example, a retailer may provide special products/gift cards to consumers in the region where the self-service order station 100 is located. A retailer may limit sale of cards for a specific sports team to self-service order stations 100 in the city where the team is located. The retailer may also provide special cards made available in a particular region for a particular event. The consumer card content management software allows retailers to control what each self-service order station presents to consumers down to the individual self-service order station at the store.

Additionally, the consumer card content management software implemented by the processing unit 104 may allow the retailers to maintain data on use of the self-service order stations. Retailers may maintain information about the number of products/cards purchased through the self-service order station 100, the values of the cards provided, other information regarding card sales, the number of adds presented to consumers, the number of instances in which the consumer selected a card consistent with an advertisement provided during card selection, and other statistical data of interest to the retailer or self-service order station provider. The retailer may also obtain information about the types of cards sold, the categories most often utilized, demographic information about the purchasers to the extent it is collected during the purchasing process, and the type of advertisements provided to those costumers. Furthermore, the retailer or self-service order station provider may capture information regarding how many times a potential costumer began to utilize the self-service order station but ultimately did not purchase a gift card from the self-service order station. The retailer may utilize this information to determine how to best utilize the self-service order stations, which locations are more conducive to the use of the self-service order stations, and overall management of the self-service order stations and the cards available at a specific self-service order station. The information may be stored in a specific database for that particular purpose. The database may be stored on the self-service order station's 100 media storage device 105 or on the network at a location accessible to the processing unit 104 and a retailer.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in light of the above teachings, those skilled in the art can modify those specifics without departing from the invention taught herein. Having now fully set forth the preferred embodiments and certain modifications of the concept underlying the invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the preferred embodiments described herein are to be considered in all respects as illustrative and not restrictive.

What is claimed is:

1. A self-service order station, comprising:
a user interface,
a product delivery apparatus, and
a processing unit configured to execute a method of advertising on said self-service order station comprising the steps of
selecting an advertisement; and
displaying said advertisement on said user interface.

2. The self-service order station of claim 1, wherein said product delivery apparatus is selected from the group consisting of a gift card printer and a photograph printer.

3. The self-service order station of claim 1, wherein said method of advertising further comprises:
creating a database of advertisements, each advertisement in said database having at least one attribute for displaying said advertisement on said user interface.

4. The self-service order station of claim 1, wherein said selecting step further comprises:
utilizing a method of selection selected from the group consisting of a random, a semi-random, and a predetermined order method.

5. The self-service order station of claim 1, further comprising:
a media storage device.

6. The self-service order station of claim 5, wherein said media storage device is located on a network accessible to the processing unit.

7. A computer readable medium having a computer readable program for executing a method of advertising on a self-service order station, comprising the steps of:
selecting an advertisement, and
displaying the advertisement on a user interface of a self-service order station.

8. The computer readable medium of claim 7, wherein said method further comprises:
creating a database of advertisements having at least one advertisement, each advertisement in said database having at least one attribute for displaying said advertisement on said user interface.

9. The computer readable medium of claim 7, wherein said selecting step further comprises:
utilizing a method of selection selected from the group consisting of a random, a semi-random, and a predetermined order method.

10. The computer readable medium of claim 8, wherein said computer readable program for executing a method of advertising on a self-service order station, further comprises:
assigning a discrete identifier to the self-service order station;
assigning a second discrete identifier to each advertisement on said database;
wherein said selecting step further comprises identifying an advertisement for a self-service order station based upon the discrete identifier of the self-service order station and the second discrete identifier assigned to said advertisement.

11. A method for advertising on a self-service order station, comprising:
providing a self-service order station, said self-service order station enabled to carry out a method for advertising;
utilizing a processing unit on said self-service order station for selecting an advertisement; and
displaying said advertisement on a user interface of said self service station.

12. The method for advertising on a self-service order station of claim 11, further comprising:
creating a database of advertisements, each advertisement in said database having at least one attribute for displaying said advertisement on said user interface.

13. The method for advertising on a self-service order station of claim 11, further comprising:
storing said database at a storage location accessible to the processing unit.

14. A management system for a self-service order station, comprising:
at least one self-service order station, wherein each of said at least one self-service order station is assigned a discrete identifier,
said at least one self-service order station, further comprising
a user interface;
a product delivery apparatus, comprising a device selected from the group consisting of a gift card printer, a photographic printer, and a card printer; and
a processing unit; and
a control server communicatively connected with the at least one self-service order station; said control server enabled to deliver content to the at least one self-service order station based upon the at least one self-service order station's discrete identifier.

15. The management system for a self-service order station of claim 14, further comprising:
at least one central server communicatively connected to said control server.

16. The management system for a self-service order station of claim 14, wherein said content is selected from the group consisting of advertisements, gift card templates, logos, pictures, messages, and graphics.

17. A self-service order station, comprising:
a user interface;
a product delivery apparatus, comprising a device selected from the group consisting of a photographic printer, a gift card printer, and a card printer; a magnetic stripe encoding apparatus; and
a processing unit configured to execute a method of advertising on said self-service order station comprising the steps of
selecting an advertisement; and
displaying said advertisement on said user interface.

18. The self-service order station of claim 17, wherein said method of advertising further comprises:
creating a database of advertisements, each advertisement in said database having at least one attribute for displaying said advertisement on said user interface.

19. The self-service order station of claim 17, wherein said selecting step further comprises:
utilizing a method of selection selected from the group consisting of a random, a semi-random, and a predetermined order method.

20. The self-service order station of claim 17, further comprising:
a media storage device, wherein said media storage device is in the self-service order station or accessible to the processing unit through a network connection.
